(19) United States
(12) Patent Application Publication
(10) Pub. No.: US 2012/0135787 A1
(43) Pub. Date: May 31, 2012

(54) MOBILE PHONE AND ECHO REDUCTION METHOD THEREFORE

(75) Inventors: Yoshiomi KUSUNOKI, Osaka (JP); Masayuki OTANI, Osaka (JP)

(73) Assignee: KYOCERA CORPORATION, Kyoto (JP)

(21) Appl. No.: 13/302,464

(22) Filed: Nov. 22, 2011

(30) Foreign Application Priority Data
Nov. 25, 2010 (JP) 2010-262070

(51) Int. Cl. H04W 88/02

(52) U.S. Cl. 455/575.8

(57) ABSTRACT

A foldable mobile phone relating to the present invention includes: a first housing that includes a speaker, a receiver and a receiver hole; and a second housing that includes a microphone and a microphone hole, the receiver hole and the microphone hole each being covered with a waterproof film, and the waterproof film that covers the receiver hole facing the microphone hole in a closed state, and the mobile phone comprises: a low-pass filter that is connected to an output terminal of the microphone and has a cut-off frequency of 1 kHz; and an echo canceller that is connected to an output terminal of the low-pass filter, and is operable to cancel, from components of a signal output from the low-pass filter, components of a signal that has been input to the speaker.

### TECHNICAL FIELD

The present invention relates to a foldable waterproof mobile phone, and particularly to an art of reducing an echo in the mobile phone.

### BACKGROUND ART

A foldable mobile phone is generally composed of a top housing in which a receiver is provided and a bottom housing in which a microphone is provided, as disclosed in Patent Literature 1. In addition to the above structure, a mobile phone disclosed in the Patent Literature 1 includes a speaker in a top housing thereof. This enables a hands-free call on the mobile phone.

Recently, there has been developed a waterproof mobile phone having a structure in which a receiver hole, a speaker hole, and a microphone hole provided in a housing are each covered with a waterproof film. In the case where a hands-free call is made on such a waterproof mobile phone, air vibration generated by a speaker is output outside the speaker, and is also propagated inside a housing. This makes a receiver to vibrate, which is provided in the housing in which the speaker is provided. Furthermore, air vibration generated by the receiver makes a waterproof film covering a receiver hole to vibrate.

As disclosed in the Patent Literature 1, a foldable mobile phone generally includes a receiver in a top housing and a microphone in a bottom housing at respective ends thereof opposite to a hinge via which the top housing and the bottom housing are coupled to each other. While such a mobile phone is in a closed state, a receiver hole and a microphone hole face each other. Due to this structure, in the case where a hands-free call is made on the mobile phone in the closed state, a noise generated by vibration of the receiver hole is input into the microphone. This causes an echo in a destination terminal.

In view of this, in order to reduce such an echo, there has been proposed a foldable mobile phone having a structure in which a microphone is provided in a bottom housing so as to be adjacent to a hinge (above operation keys), such that the microphone and a receiver do not face each other in a closed state.

### CITATION LIST

### Patent Literature

[Patent Literature 1] Japanese Patent Application Publication No. 2007-201653

### SUMMARY OF INVENTION

### Technical Problem

However, a microphone of a mobile phone is generally provided at an end of a bottom housing. If the microphone is provided above operation keys as described above, restrictions are imposed on designing, and this results in making a user to feel strange. Furthermore, there is a possibility that while a user is making a call with such a mobile phone in his hand, the user unconsciously covers a microphone hole with his finger.

In view of the above problem, the present invention aims to provide a mobile phone capable of reducing occurrence of an echo and an echo reduction method for the mobile phone.

### Solution to Problem

In order to achieve the above aim, the present invention provides a foldable mobile phone that includes: a first housing that includes a speaker, a receiver and a receiver hole formed adjacent thereto; and a second housing that includes a microphone and a microphone hole formed adjacent thereto, the receiver hole and the microphone hole each being covered with a waterproof film, and in a closed state where the first housing and the second housing overlap each other, the waterproof film that covers the receiver hole facing the microphone hole, the mobile phone comprising: a low-pass filter that is connected to an output terminal of the microphone; and an echo canceller that is connected to an output terminal of the low-pass filter, and is operable to cancel, from components of a signal output from the low-pass filter, components of a signal that has been input to the speaker.

### Advantageous Effects of Invention

With this structure, the mobile phone relating to the present invention is can reduce occurrence of an echo.

### BRIEF DESCRIPTION OF DRAWINGS

FIG. 1A is an external view showing a mobile phone 1 in an open state, and FIG. 1B is an external view showing the mobile phone 1 in a closed state.

FIG. 2A is a cross-sectional view showing the mobile phone 1, taken along a line X-X′, and FIG. 2B is an enlarged view showing a part A of the mobile phone 1.

FIG. 3 shows an audio processing circuit of the mobile phone 1.

FIG. 4 shows attenuation characteristics of a low-pass filter 110.

FIG. 5 shows effects of an embodiment, and specifically shows frequency characteristics of a signal input from an echo canceller in the case where a monaural sound of 400 Hz is output from a speaker.

### DESCRIPTION OF EMBODIMENT

The following describes a mobile phone 1 as an embodiment of a mobile phone relating to the present invention, with reference to the drawings.

### <Structure>

The mobile phone 1 is a foldable mobile phone composed of two housings coupled to each other via a hinge.

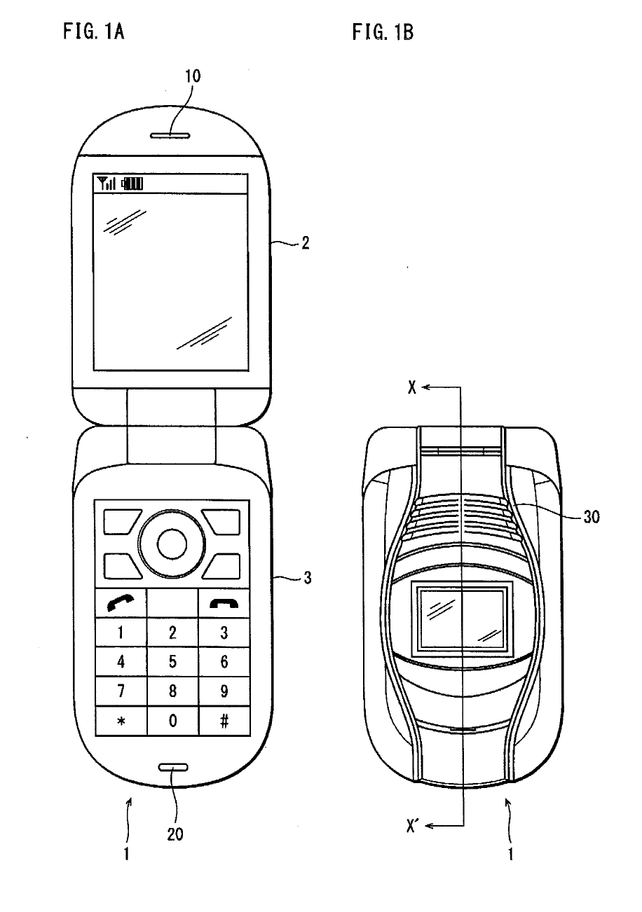

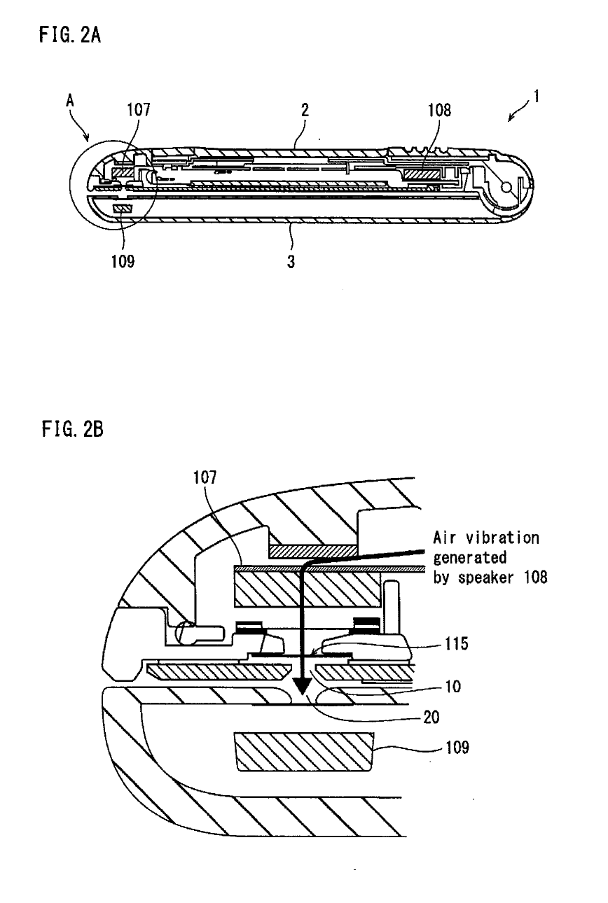

FIG. 1A is an external view showing the mobile phone 1 in an open state, and FIG. 1B is an external view showing the mobile phone 1 in a closed state (where the housings are folded). FIG. 2A is a cross-sectional view showing the mobile phone 1 in the closed state, taken along a line X-X′, and FIG. 2B is an enlarged view showing a part A of the mobile phone 1 which is circled in FIG. 2A. Note that FIG. 2A and FIG. 2B show only structural elements necessary for describing the embodiment.

As shown in FIG. 1A, the mobile phone 1 is composed of a top housing 2 and a bottom housing 3, which are a first housing and a second housing relating to the present invention, respectively.

The top housing 2 includes a receiver 107 and a speaker 108 that each externally output a received sound, a display, and so on. The receiver 107 is an on-ear type earpiece, and is used for a hand-set call which is made by a user holding the mobile phone 1 to his ear with his hand. The speaker 108 is used for a hands-free call for example, and outputs a received sound at a sound pressure level higher than the receiver 107. The bottom housing 3 includes a microphone 109 that collects sounds, operation keys, and so on.

As shown in FIG. 1A, the top housing 2 has a receiver hole 10 which corresponds in position to the receiver 107 and a microphone hole 20 which corresponds in position to the microphone 109. Furthermore, as shown in FIG. 1B, the bottom housing 3 has a speaker hole 30 which corresponds in position to the speaker 108. Here, the receiver hole 10, the microphone hole 20, and the speaker hole 30 are each covered with a Waterproof film, thereby realizing the mobile phone 1 with a waterproof function.

The waterproof film is made of a waterproof sheet member, and prevents moisture infiltration into the housings. Also, the waterproof film propagates a sound wave by vibrating in synchronization with air vibration. As the waterproof film, GORE-TEX™ products may be employed, for example.

As shown in FIG. 2A, inside the top housing 2, there is not provided a member partitioning the receiver 107 and the speaker 108. Due to this, when the speaker 108 operates, vibration generated by the speaker 108 is propagated inside the top housing 2 through air.

Then, as shown in FIG. 2B, the air vibration generated by the speaker 108 reaches the receiver 107 thereby to make a diaphragm of the receiver 107 to vibrate. Furthermore, the vibration generated by the receiver 107 makes a waterproof film 115 covering the receiver hole 10 to generate air vibration. While the mobile phone 1 is in the closed state, the waterproof film 115 faces the microphone hole 20. Accordingly, in the case where a hands-free call is made on the mobile phone 1 in the closed state, the microphone 109 collects a vibration sound (noise) generated by the waterproof film 115 together with the user's voice.

### <Audio Processing Circuit>

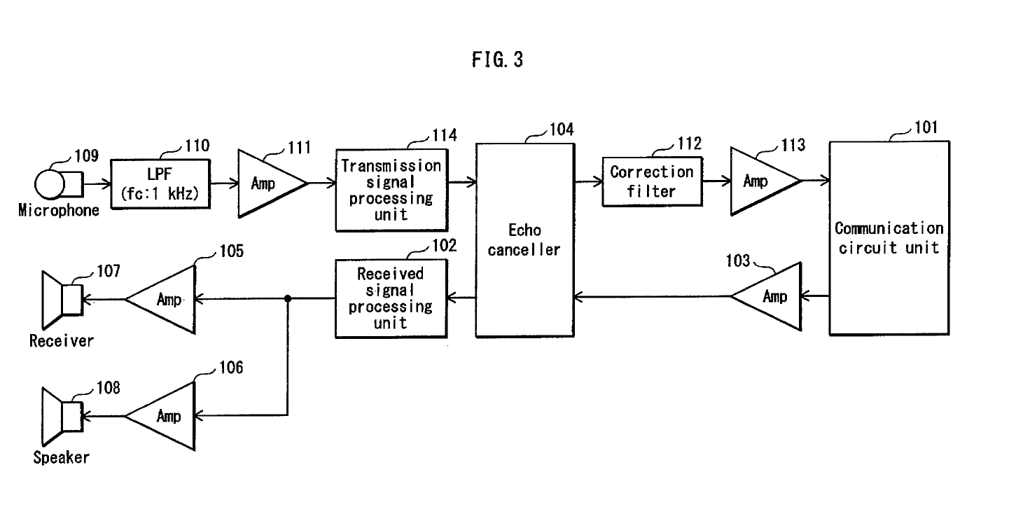

Next, the audio processing circuit of the mobile phone 1 is described with reference to FIG. 3.

As shown in FIG. 3, the mobile phone 1 includes a communication circuit unit 101, a received signal processing unit 102, an amplifier 103, an echo canceller 104, an amplifier 105, an amplifier 106, the receiver 107, the speaker 108, the microphone 109, a low-pass filter (LPF) 110, a correction filter 112, an amplifier 113, and a transmission signal processing unit 114. Although the mobile phone 1 actually includes a control unit composed of a CPU, a ROM, a RAM, and so on, FIG. 3 shows only the audio processing circuit.

The communication circuit unit 101 has a function of performing high-frequency wireless communication with a base station via an antenna which is not shown in the figure. The communication circuit unit 101 outputs a received signal, which has been received from the base station, to the amplifier 103. Also, the communication circuit unit 101 transmits a transmission signal, which has been received from the amplifier 113, to the base station.

The echo canceller 104 has a function of cancelling an echo generated due to that a sound output from the receiver 107 and the speaker 108 enters through the microphone 109. Specifically, the echo canceller 104 generates a pseudo echo signal from a received signal amplified by the amplifier 103 with use of a predetermined algorithm, and temporarily stores therein the generated pseudo echo signal. Then, the echo canceller 104 subtracts the pseudo echo signal from a transmission signal output from the transmission signal processing unit 114, thereby to cancel echo components contained in the transmission signal. Also, the echo canceller 104 outputs a received signal, which has been input from the amplifier 103, to the received signal processing unit 102.

The received signal processing unit 102 performs D/A converts the received signal, which has been received from the echo canceller 104, so as to be demodulated to a received voice signal. The received signal processing unit 102 outputs the demodulated received voice signal to the amplifier 105 or the amplifier 106. In the case where a hand-set call is made on the mobile phone 1, the received signal processing unit 102 outputs the demodulated received voice signal to the amplifier 105. Also, in the case where a hands-free call is made on the mobile phone 1, the received signal processing unit 102 outputs the demodulated received voice signal to the amplifier 106.

The received voice signal amplified by the amplifier 105 is output from the receiver 107. The received voice signal amplified by the amplifier 106 is output from the speaker 108.

The microphone 109 has a function of collecting the user's voice, and electrically converting the collected user's voice into a transmission voice signal. As described above, in the case where a hands-free call is made on the mobile phone 1 in the closed state, the microphone 109 collects nonlinear distortion components resulting from vibration generated by the waterproof film 115. This results in a transmission voice signal containing the nonlinear distortion components.

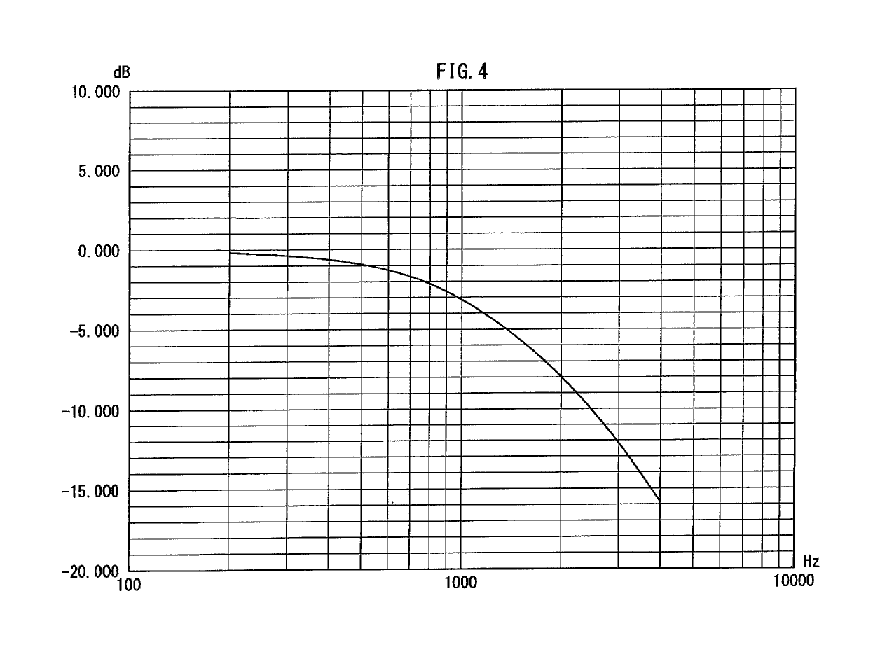

The low-pass filter 110 is a filter circuit that has a cut-off frequency (fc) of 1 kHz, and is used for reducing the nonlinear distortion components resulting from the vibration generated by the waterproof film 115 and causing the user's voice components to efficiently pass through. FIG. 4 shows attenuation characteristics of the low-pass filter 110. As an example of the low-pass filter 110, a two-stage RC filter is used here, which is composed of a combination of a resistor R and a capacitor C.

A human male voice has main components of 300 Hz to 800 Hz, and a human female voice has main components of 500 Hz to 1 kHz. On the other hand, in the case where components of a human voice are set as a fundamental wave, the nonlinear distortion components resulting from the vibration generated by the waterproof film 115 contains increased high-frequency components equivalent to frequency components of a fourth or higher harmonic wave of the fundamental wave. In view of this, the low-pass filter 110 is set to have a cut-off frequency of 1 kHz. This reduces the nonlinear distortion components resulting from the vibration generated by the waterproof film, thereby to allow components of the user's voice to pass through at an improved S/N ratio.

The transmission voice signal, from which the nonlinear distortion components have been reduced by the low-pass filter 110, is amplified by the amplifier 111, and then is input to the transmission signal processing unit 114.

The transmission signal processing unit 114 A/D converts the transmission voice signal to generate a transmission signal, and outputs the generated transmission signal to the echo canceller 104.

The echo canceller 104 cancels echo components by subtracting a pseudo echo signal from a signal output from the amplifier 111, as described above.

Here, nonlinear distortion components resulting from the vibration generated by the waterproof film 115 have frequency characteristics greatly different from frequency characteristics of a received voice signal. For this reason, even subtraction of a pseudo echo signal cannot cancel nonlinear distortion components. In the case where a large amount of nonlinear distortion components, which cannot be cancelled by just subtracting a pseudo echo signal, exist in an input stage of the echo canceller 104, this deteriorates the echo component cancellation capability of the echo canceller 104.

In view of this, the low-pass filter 110 is inserted between the microphone 109 and the echo canceller 104 so as to reduce the nonlinear distortion components in the input stage of the echo canceller 104. This improves the echo component cancellation capability of the echo canceller 104.

The echo canceller 104 outputs the transmission signal, from which echo components have been cancelled, to the correction filter 112.

The correction filter 112 is a correction circuit for correcting components in a frequency band of 1 kHz or higher, which have been reduced by the low-pass filter 110.

The low-pass filter 110 reduces both components of a transmission voice and echo components (including nonlinear distortion components) in a frequency band of 1 kHz or higher. Furthermore, the echo canceller 104 reduces echo components all over the frequency bands. As a result, a signal to be input to the correction filter 112 has sound quality characteristics in which echo components have been effectively reduced and the transmission voice contains emphasized low pass components. This leads to a possibility that if this signal is transmitted to a destination terminal without being processed, a sound quality is exhibited where a sound is rather muffled.

In view of this, the correction filter 112 makes a correction to increase components in a frequency band of 1 kHz or higher, such that a transmission signal which is to be output has appropriate frequency characteristics. This improves a sound quality in the destination terminal.

The transmission signal output from the correction filter 112 is amplified by the amplifier 113, and then is input to the communication circuit unit 101.

### Effects of Embodiment

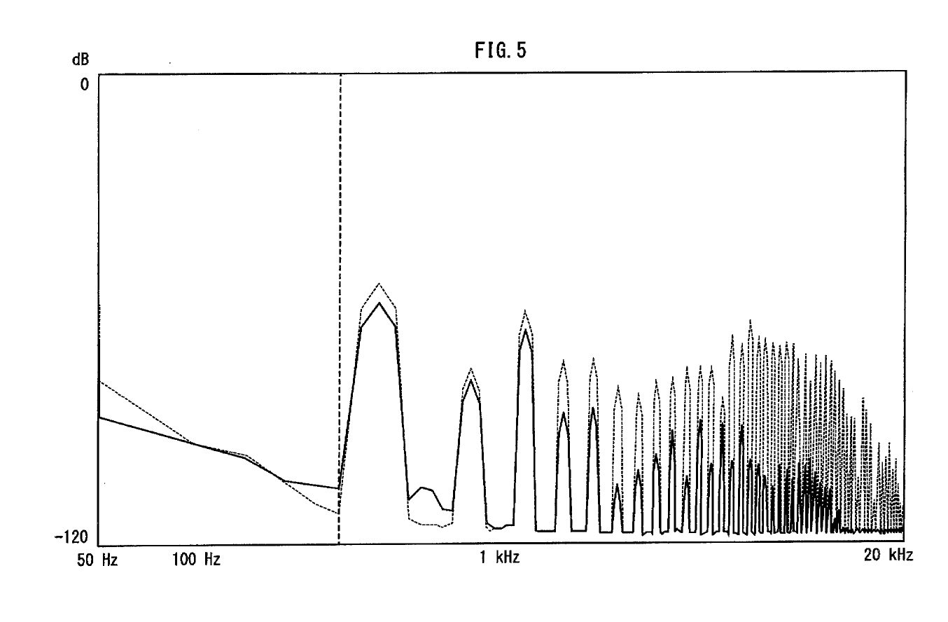

Here, effects of the present embodiment are described with reference to FIG. 5.

In FIG. 5, a mobile phone is used, which has a structure in which although a waterproof film is provided, a low-pass filter is not inserted into an audio processing circuit. With respect to this mobile phone, dashed lines represent frequency characteristics of a signal input from an echo canceller in the case where a monaural sound of 400 Hz is output from a speaker at a sound pressure level of 85 dBspl/10 cm. As shown in FIG. 5, all over the audible bands, nonlinear distortion components are generated due to vibration of the waterproof film provided in front of a microphone.

On the other hand, the mobile phone 1 of the present embodiment has the structure in which the waterproof films are provided and the low-pass filter 110 having a cut-off frequency of 1 kHz is inserted into the audio processing circuit. With respect to the mobile phone 1, solid lines represent frequency characteristics of a signal input from the echo canceller 104 in the case where a monaural sound of 400 Hz is output from the speaker 108 at a sound pressure level of 85 dBspl/10 cm. Compared with the mobile phone having the audio processing circuit into which a low-pass filter is not inserted, the mobile phone 1 can effectively reduce nonlinear distortion components in the input stage of the echo canceller 104.

Furthermore, with respect to the mobile phone having the audio processing circuit into which a low-pass filter is not inserted, an echo return loss, which is calculated based on a transmission signal level and a reception signal level in a destination terminal, is 12 dB. Compared to this, with respect to the mobile phone 1 having the audio processing circuit into which the low-pass filter 110 is inserted, an echo return loss is improved to be 30 dB.

### <Modification Examples>

Although the embodiment of the mobile phone and the echo reduction method relating to the present invention have been described, the exemplified mobile phone 1 may be modified as follows. The present invention is, of course, not limited to the mobile phone 1 described in the above embodiment.

(1) The position where the speaker 108 is to be provided in the mobile phone 1 does not necessarily need to be the same as shown in FIG. 2. The speaker 108 at least only needs to be provided in the same housing in which the receiver 107 is provided. Also, the position where the speaker hole 30 is to be provided in the top housing 2 does not necessarily need to be the back side of the top housing 2 as shown in FIG. 1. The speaker hole 30 may be provided in a lateral side of the top housing 2.
(2) The position where each of the receiver 107 and the microphone 109 is to be provided in the mobile phone 1 does not necessarily need to be the same as shown in FIG. 2. The receiver hole 10 and the microphone hole 20 at least only need to be provided, such that the receiver hole 10 and the microphone hole 20 face each other or the waterproof film covering the receiver hole 10 and the waterproof film covering the microphone hole 20 face each other.
(3) The low-pass filter 110 used in the above embodiment is a two-stage RC filter, and has attenuation characteristics shown in FIG. 4. Alternatively, a low-pass filter other than a two-stage RC filter may be used in the present invention.
(4) In the above embodiment, the low-pass filter 110 has a cut-off frequency of 1 kHz. However, a cut-off frequency of a low-pass filter for the present invention is not limited to this. For example, in the case where a human male voice is collected by a microphone, a cut-off frequency of a low-pass filter may be set to 800 Hz in consideration of components of the human male voice. In this way, the cut-off frequency of the low-pass filter may be appropriately changed.

### <Supplementary Description>

The following further describes the structure of the mobile phone as an embodiment of the present invention, modifications, and effects thereof.

(a) A mobile phone relating to one embodiment of the present invention includes: a first housing that includes a speaker, a receiver and a receiver hole formed adjacent thereto; and a second housing that includes a microphone and a microphone hole formed adjacent thereto, the receiver hole and the microphone hole each being covered with a waterproof film, and in a closed state where the first housing and the second housing overlap each other, the waterproof film that covers the receiver hole facing the microphone hole, and the mobile phone comprises: a low-pass filter that is connected to an output terminal of the microphone; and an echo canceller that is connected to an output terminal of the low-pass filter, and is operable to cancel, from components of a signal output from the low-pass filter, components of a signal that has been input to the speaker.

With this structure, it is possible to reduce high-frequency nonlinear distortion components contained in a signal to be output from the microphone. This improves the echo component cancellation capability of the echo canceller, thereby reducing occurrence of an echo in a destination terminal

(b) The low-pass filter may have a cut-off frequency of 1 kHz.

A human male voice has main components of 300 Hz to 800 Hz, and a human female voice has main components of 500 Hz to 1 kHz. On the other hand, in the case where components of a human voice are set as a fundamental wave, the nonlinear distortion components resulting from the vibration generated by the waterproof film 115 contains increased high-frequency components equivalent to frequency components of a fourth or higher harmonic wave of the fundamental wave.

In view of this, a low-pass filter having a cut-off frequency of 1 kHz is inserted between the microphone and the echo canceller. As a result, even in the case where the speaker operates in the closed state, it is possible to reduce nonlinear distortion components resulting from the vibration generated from the waterproof film covering the receiver hole, thereby to allow components of the user's voice to effectively pass through. As a result, the mobile phone maintains the capability of the echo canceller for echo component cancellation, thereby reducing occurrence of an echo in the destination terminal.

(c) The mobile phone may further comprise a correction filter that is connected to an output terminal of the echo canceller, and is operable to correct frequency components of a signal output from the echo canceller such that frequency characteristics of the signal are substantially equalized.

With this structure, high-frequency components, which have been reduced by the low-pass filter 110, are corrected, thereby improving a sound quality in the destination terminal.

(d) The correction filter may correct the frequency components of 1 kHz or higher.

With this structure, high-frequency components of 1 kHz or higher, which have been reduced by the low-pass filter 110, are corrected such that frequency characteristics are substantially equalized ranging from low-pass components to high-pass components. This improves a sound quality in the destination terminal.

(e) An echo reduction method for use in a foldable mobile phone relating to one embodiment of the present invention includes: a first housing that includes a speaker, a receiver and a receiver hole formed adjacent thereto; and a second housing that includes a microphone and a microphone hole formed adjacent thereto, the receiver hole and the microphone hole each being covered with a waterproof film, and in a closed state where the first housing and the second housing overlap each other, the waterproof film that covers the receiver hole and the microphone hole facing each other, and the echo reduction method comprises: a first step of cancelling high-frequency components from a signal output from the microphone; and a second step of cancelling, from the signal from which the high-frequency components have been cancelled in the first step, components of a signal that has been input to the speaker.

With this method, even in the case where the speaker operates in the closed state, it is possible to reduce nonlinear distortion components resulting from vibration generated from the waterproof film covering the receiver hole, thereby to allow components of the user's voice to effectively pass through. As a result, the mobile phone maintains the capability of the echo canceller for echo component cancellation, thereby reducing occurrence of an echo in the destination terminal.

### INDUSTRIAL APPLICABILITY

The present invention is utilizable, in the industry of manufacturing and selling foldable waterproof mobile phones, as a mechanism for reducing an echo due to vibration generated by a waterproof film.

### REFERENCE SIGNS LIST

1 mobile phone
2 top housing
3 bottom housing
10 receiver hole
20 microphone hole
30 speaker hole
101 communication circuit unit
102 received signal processing unit
103 amplifier
104 echo canceller
105 amplifier
106 amplifier
107 receiver
108 speaker
109 microphone
110 low-pass filter
111 amplifier
112 correction filter
113 amplifier
114 transmission signal processing unit
115 waterproof film

1. A foldable mobile phone that includes: a first housing that includes a speaker, a receiver and a receiver hole formed adjacent thereto; and a second housing that includes a microphone and a microphone hole formed adjacent thereto, the receiver hole and the microphone hole each being covered with a waterproof film, and in a closed state where the first housing and the second housing overlap each other, the waterproof film that covers the receiver hole facing the microphone hole, the mobile phone comprising:
a low-pass filter that is connected to an output terminal of the microphone; and
an echo canceller that is connected to an output terminal of the low-pass filter, and is operable to cancel, from components of a signal output from the low-pass filter, components of a signal that has been input to the speaker.

2. The mobile phone of claim 1, wherein
the low-pass filter has a cut-off frequency of 1 kHz.

3. The mobile phone of claim 1, further comprising
a correction filter that is connected to an output terminal of the echo canceller, and is operable to correct frequency components of a signal output from the echo canceller such that frequency characteristics of the signal are substantially equalized.

4. The mobile phone of claim 3, wherein
the correction filter corrects the frequency components of 1 kHz or higher.

5. An echo reduction method for use in a foldable mobile phone that includes: a first housing that includes a speaker, a receiver and a receiver hole formed adjacent thereto; and a second housing that includes a microphone and a microphone hole formed adjacent thereto, the receiver hole and the microphone hole each being covered with a waterproof film, and in a closed state where the first housing and the second housing overlap each other, the waterproof film that covers the receiver hole and the microphone hole facing each other, the echo reduction method comprising:
a first step of cancelling high-frequency components from a signal output from the microphone; and
a second step of cancelling, from the signal from which the high-frequency components have been cancelled in the first step, components of a signal that has been input to the speaker.
